(19) United States
(12) Patent Application Publication
(10) Pub. No.: US 2011/0163165 A1
(43) Pub. Date: Jul. 7, 2011

(54) TERMINAL HAVING ILLUMINATION AND FOCUS CONTROL

(75) Inventors: Yong Liu, Suzhou (CN); Xiaoxun Zhu, Marlton, NJ (US); Ynjiun Paul Wang, Cupertino, CA (US)

(73) Assignees: Metrologic Instruments, Inc., Blackwood, NJ (US); Hand Held Instruments, Skaneateles Falls, NY (US)

(21) Appl. No.: 12/683,779

(22) Filed: Jan. 7, 2010

(51) Int. Cl. G06K 7/10

(52) U.S. Cl. 235/472.01; 235/462.28; 235/462.48; 235/462.42

(57) ABSTRACT

There is set forth herein an indicia reading terminal having an illumination subsystem for projection of an illumination pattern, the illumination subsystem having at least one light source, the illumination subsystem being switchable between a first state and a second state, wherein the illumination subsystem in the second state projects illumination light at a projection angle that is more narrow than a projection angle of illumination light projected by the illumination subsystem when the illumination subsystem is in the first state. An indicia reading terminal can include an imaging subsystem including an image sensor array and an imaging lens for focusing an image of a target onto the image sensor array, the imaging lens being a variable imaging lens and having a first lens setting at which the lens assembly has a relatively nearer plane of optimum focus and a second lens setting at which the imaging lens has a relatively farther plane of optimum focus setting.

### FIELD OF THE INVENTION

The present invention relates in general to optical based registers, and particularly is related to an image sensor based indicia reading terminal.

### BACKGROUND OF THE INVENTION

Indicia reading terminals for reading decodable indicia are available in multiple varieties. For example, minimally featured indicia reading terminals devoid of a keyboard and display are common in point of sale applications. Indicia reading terminals devoid of a keyboard and display are available in the recognizable gun style form factor having a handle and trigger button (trigger) that can be actuated by an index finger. Indicia reading terminals having keyboards and displays are also available. Keyboards and display equipped indicia reading terminals are commonly used in shipping and warehouse applications, and are available in form factors incorporating a display and keyboard. In a keyboard and display equipped indicia reading terminal, a trigger button for actuating the output of decoded messages is typically provided in such locations as to enable actuation by a thumb of an operator. Indicia reading terminals in a form devoid of a keyboard and display or in a keyboard and display equipped form are commonly used in a variety of data collection applications including point of sale applications, shipping applications, warehousing applications, security check point applications, and patient care applications. Some indicia reading terminals are adapted to read bar code symbols including one or more of one dimensional (1D) bar codes, stacked 1D bar codes, and two dimensional (2D) bar codes. Other indicia reading terminals are adapted to read OCR characters while still other indicia reading terminals are equipped to read both bar code symbols and OCR characters.

### SUMMARY OF THE INVENTION

There is set forth herein an indicia reading terminal having an illumination subsystem for projection of an illumination pattern, the illumination subsystem having at least one light source, the illumination subsystem being switchable between a first state and a second state, wherein the illumination subsystem in the second state projects illumination light at a projection angle that is more narrow than a projection angle of illumination light projected by the illumination subsystem when the illumination subsystem is in the first state. An indicia reading terminal can include an imaging subsystem including an image sensor array and an imaging lens for focusing an image of a target onto the image sensor array, the imaging lens being a variable imaging lens and having a first lens setting at which the lens assembly has a relatively nearer plane of optimum focus and a second lens setting at which the imaging lens has a relatively farther plane of optimum focus setting.

### BRIEF DESCRIPTION OF THE DRAWINGS

The features described herein can be better understood with reference to the drawings described below. The drawings are not necessarily to scale, emphasis instead generally being placed upon illustrating the principles of the invention. In the drawings, like numerals are used to indicate like parts throughout the various views.

FIG. 1 is a side schematic view of an indicia reading terminal having an illumination subsystem and an imaging subsystem;

FIG. 2 is an exploded perspective assembly view of an imaging module of a first featurization;

FIG. 3 is an exploded perspective assembly view of an imaging module of a second featurization;

FIG. 4 is an assembled perspective assembly view of an imaging module of the first featurization;

FIG. 5 is an assembled perspective assembly view of an imaging module of the second featurization;

FIG. 6 is a block diagram of an indicia reading terminal;

FIGS. 7-9 are block diagrams of various embodiment of variable lens assemblies for use in an illumination subsystem or an imaging subsystem;

FIG. 10 is a timing diagram illustrating an association between a lens setting and an illumination state;

FIG. 11 is a perspective view of an indicia reading terminal having a plurality of operator selectable configurations.

### DETAILED DESCRIPTION OF THE INVENTION

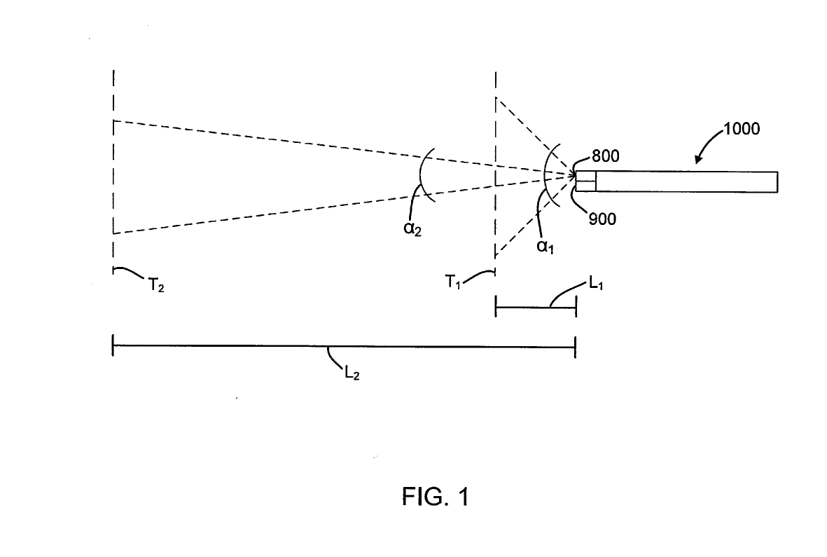

Referring to FIG. 1, there is set forth herein an indicia reading terminal 1000 having an illumination subsystem 800 for projection of an illumination pattern, the illumination subsystem 800 having at least one light source, the illumination subsystem 800 being switchable between a first state and a second state, wherein the illumination subsystem 800 in the second state projects illumination light at a projection angle, α₁, that is more narrow than a projection angle, α₂, of illumination light projected by the illumination subsystem when the illumination subsystem is in the first state. In the development of terminal 1000, it was noted that by switching to the second state (narrower projection angle) illumination subsystem 800 more readily provides sufficient illumination to a target at long terminal to target distances, and with improved energy efficiency. Referring to FIG. 1, the first illumination state can optimize terminal 1000 for reading of decodable indicia on a target, T₁, at a relatively nearer terminal to target distance, L₁. The second illumination state can optimize terminal 1000 for reading of decodable indicia on a target T₂ at a relatively farther terminal to target distance L₂.

As will be described in further detail herein indicia reading terminal 1000 can include an imaging subsystem 900 including an image sensor array and an imaging lens for focusing an image of a target onto the image sensor array, the imaging lens being a variable imaging lens and having a first lens setting at which the lens assembly has a relatively nearer plane of optimum focus and a second lens setting at which the imaging lens has a relatively farther plane of optimum focus setting.

Indicia reading terminal 1000 can be operative so that during exposure periods of the image sensor array with the first lens setting active the first state of the illumination subsystem is active and further so that during exposure periods of the image sensor array with the second lens setting active the second state of the illumination subsystem is active.

In one aspect as will be described herein, indicia reading terminal 1000 can be operative to expose a first frame of image data with the first lens setting and first state active, and a second frame of image data with the second lens setting and second state active.

In another aspect as will be set forth herein, indicia reading terminal 1000 can be operative to attempt to decode a decodable indicia utilizing each of the first frame of image data and the second frame of image data.

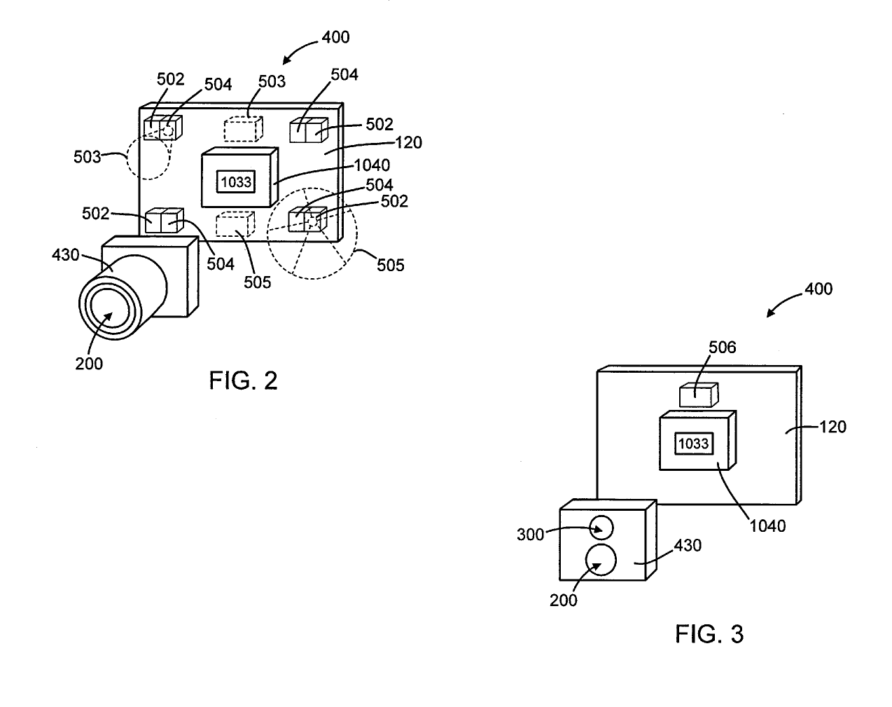

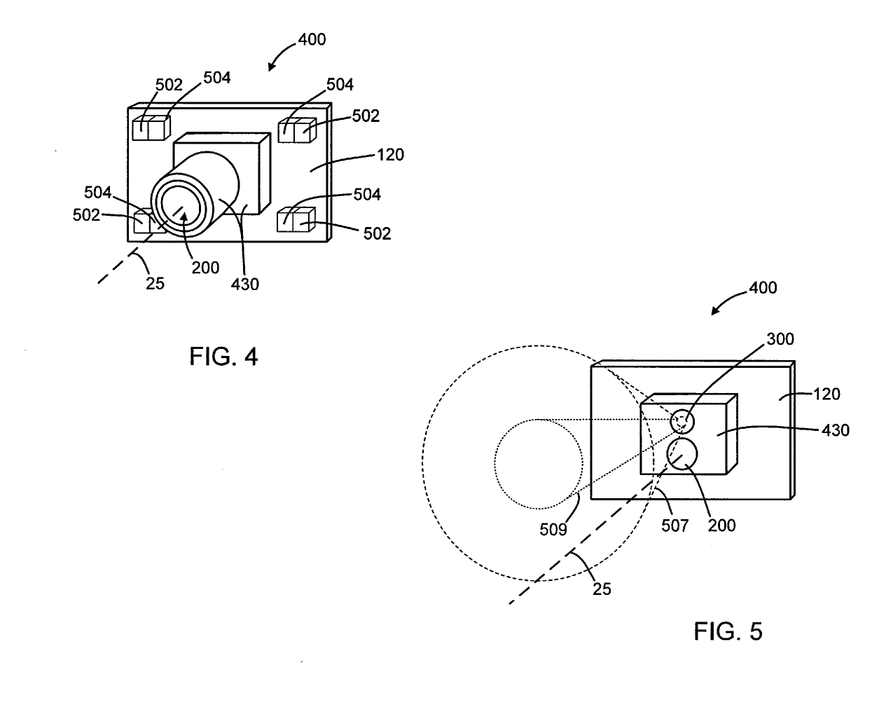

Illumination subsystem 800 can include a number of alternative featurizations that adapt the illumination subsystem for projecting illumination light at a plurality of projection angles. In one embodiment, elements of an illumination subsystem 800 and an imaging subsystem can be incorporated into an imaging module 400. Exemplary imaging modules 400 are shown in FIGS. 2-5. Each of the exemplary imaging modules 400 can include a printed circuit board 120 carrying an image sensor integrated circuit 1040 having an image sensor array 1033. Each of the exemplary imaging modules 400 can include an imaging lens assembly 200 supported by a support assembly 430. An imaging subsystem in each of the modules of FIGS. 2 and 3 can comprise an image sensor array 1033 which can be integrated onto image sensor integrated circuit 1040 in combination with imaging lens assembly 200. Imaging lens assembly 200 can be a variable imaging lens assembly capable of multiple lens settings including a first lens setting at which a plane of optimum focus is relatively nearer the terminal 1000 and a second lens setting at which a plane of optimum focus of the lens assembly 200 is relatively farther from terminal 1000.

Referring more particularly to the imaging module of FIG. 2, imaging module 400 can have a plurality of light sources 502, 504 that can be mounted to printed circuit board 420. In the embodiment of FIG. 2, illumination subsystem 800 is provided by light sources 502, 504. Light sources 502, 504 can be conveniently provided by LEDs. Light sources 502, 504 can be divided into first and second banks of light sources. Specifically light sources 502, 504 can be light sources of a first bank and light sources 504 can be light sources of a second bank. Light sources 502 of the first bank can have a first projection angle as represented by cone 503 and light sources 504 of the second bank can have a second projection angle represented by cone 505. Terminal 1000 can be operative to energize the light sources 502 of the first bank independently of light sources 504 of the second bank. An illumination subsystem comprising light sources 502, 504 can be driven into a first state by energizing light sources 502 of a first bank without energizing light sources 504 of a second bank, and into a second state by energizing light sources 504 of the second bank without energizing light sources of the 502 first bank. A projection angle α₁ of emitted light emitted by illumination subsystem 800 along a planar cross-section as shown in FIG. 1 can be defined by the combination of outer most light rays defining the various projection angles indicated by cones 503, 505, of individual light sources 502, 504 making up each separately controlled bank. In the described example, it is seen that a projection angle α₂, of illumination subsystem 800 with light sources 504 energized will be relatively narrower than projection angle α₁, of illumination subsystem 800 with light sources 502 energized. Terminal 1000 can be operative so that the first state of the illumination subsystem 800 is associated to the first relatively nearer plane of optimum focus lens setting and further so that the second state of the illumination subsystem is associated to the second farther plane of optimum focus lens setting. Terminal 1000 can be operative so that during exposure periods of image sensor array 1033 at which the first lens setting is active the first state is active and can be further operative so that during exposure periods of image sensor array 1033 at which the second lens setting is active the second state is active. In the example of FIG. 2, the first light source bank for projection of illumination light at first projection angle α₁, and the second light source bank for projection of illumination light at second projection angle α₂, can each include multiple light sources. However, in another embodiment, the first light source bank can be provided by a single light source, as indicated by dashed-in light source 503 having a projection angle of α₁, and a second light source bank can include a single light source 505 having a projection angle of α₂.

Referring to the imaging module of FIG. 3, an illumination subsystem 800 of imaging module 400 can include a light source 506 in combination with a variable illumination lens assembly 300. Variable illumination lens assembly 300 can be variable between a first variable illumination lens setting at which a projection angle, α₁ (as shown in FIG. 1) of emitted illumination emitted by illumination subsystem 800 is relatively wider and a second variable illumination setting at which a projection angle α₂, of emitted illumination emitted by illumination subsystem 800 is relatively narrower. The projection angles α₁ and α₂ are indicated by cones 507 and 509 respectively as shown in FIG. 3. Terminal 1000 can be operative so that the first state of the illumination subsystem 800 is defined when the variable illumination lens assembly 300 is at the first variable illumination lens setting. Terminal 1000 can be operative so that the second state of the illumination subsystem 800 is defined when the variable illumination lens assembly 300 is at the second variable illumination lens setting. Terminal 1000 can be operative so that the second state of the illumination subsystem 800 (relatively narrower projection of illumination light) is defined when the variable illumination lens assembly is at the second lens setting.

Referring to the imaging module of FIG. 3, an illumination subsystem 800 of imaging module 400 can include a light source 506 in combination with a variable illumination lens assembly 300. Variable illumination lens assembly 300 can be variable between a first variable illumination lens setting at which a projection angle, α₁ (as shown in FIG. 1) of emitted illumination is relatively wider and a second variable illumination setting at which a projection angle α₂, of emitted illumination emitted by the illumination subsystem is relatively narrow. The projection angles α₁ and α₂ are indicated by cones 507 and 509 respectively as shown in FIG. 3. Terminal 1000 can be operative so that the first state of the illumination subsystem 800 is defined when the variable illumination lens assembly 300 is at the first variable illumination lens setting. Terminal 1000 can be operative so that the second state of the illumination subsystem 800 is defined when the variable illumination lens assembly 300 is at the second variable illumination lens setting. Terminal 1000 can be operative so that the second state of the illumination subsystem 800 (relatively narrower projection of illumination light) is defined when the variable illumination lens assembly is at the second lens setting. Variable illumination lens assembly 300 can include a plano-concave or bi-concave negative lens.

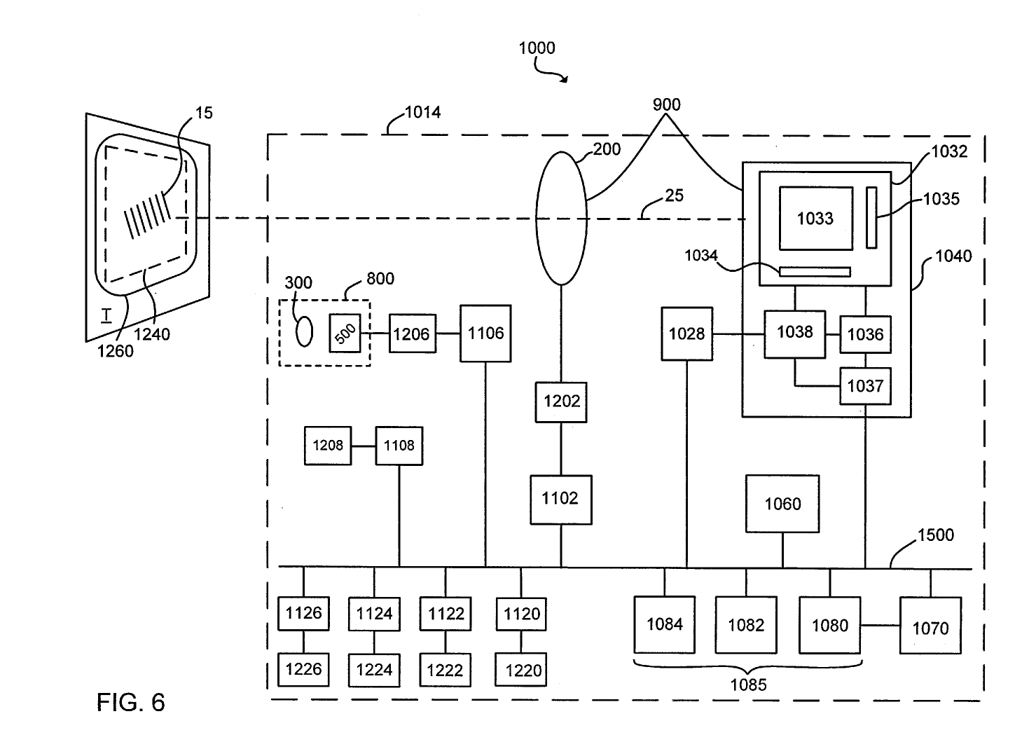

An exemplary hardware platform for support of operations described herein with reference to an image sensor based indicia reading terminal is shown and described with reference to FIG. 6.

Indicia reading terminal 1000 can include an image sensor 1032 comprising a multiple pixel image sensor array 1033 having pixels arranged in rows and columns of pixels, associated column circuitry 1034 and row circuitry 1035. Associated with the image sensor 1032 can be amplifier circuitry 1036 (amplifier), and an analog to digital converter 1037 which converts image information in the form of analog signals read out of image sensor array 1033 into image information in the form of digital signals. Image sensor 1032 can also have an associated timing and control circuit 1038 for use in controlling e.g., the exposure period of image sensor 1032, gain applied to the amplifier 1036. The noted circuit components 1032, 1036, 1037, and 1038 can be packaged into a common image sensor integrated circuit 1040. Image sensor integrated circuit 1040 can incorporate fewer than the noted number of components. In one example, image sensor integrated circuit 1040 can be provided e.g., by an MT9V022 (752×480 pixel array) or an MT9V023 (752×480 pixel array) image sensor integrated circuit available from Micron Technology, Inc. In one example, image sensor integrated circuit 1040 can incorporate a Bayer pattern filter, so that defined at the image sensor array are red pixels at red pixel positions, green pixels at green pixel positions, and blue pixels at blue pixel positions. Frames that are provided utilizing such an image sensor array incorporating a Bayer pattern can include red pixel values at red pixel positions, green pixel values at green pixel positions, and blue pixel values at blue pixel positions. In an embodiment incorporating a Bayer pattern image sensor array, CPU 1060 prior to subjecting a frame to further processing can interpolate pixel values at frame pixel positions intermediate of green pixel positions utilizing green pixel values for development of a monochrome frame of image data. Alternatively, CPU 1060 prior to subjecting a frame for further processing can interpolate pixel values intermediate of red pixel positions utilizing red pixel values for development of a monochrome frame of image data. CPU 1060 can alternatively prior to subjecting a frame for further processing can interpolate pixel values intermediate of blue pixel positions utilizing blue pixel values.

In the course of operation of terminal 1000, image signals can be read out of image sensor 1032, converted, and stored into a system memory such as RAM 1080. A memory 1085 of terminal 1000 can include RAM 1080, a nonvolatile memory such as EPROM 1082 and a storage memory device 1084 such as may be provided by a flash memory or a hard drive memory. In one embodiment, terminal 1000 can include CPU 1060 which can be adapted to read out image data stored in memory 1080 and subject such image data to various image processing algorithms. Terminal 1000 can include a direct memory access unit (DMA) 1070 for routing image information read out from image sensor 1032 that has been subject to conversion to RAM 1080. In another embodiment, terminal 1000 can employ a system bus providing for bus arbitration mechanism (e.g., a PCI bus) thus eliminating the need for a central DMA controller. A skilled artisan would appreciate that other embodiments of the system bus architecture and/or direct memory access components providing for efficient data transfer between the image sensor 1032 and RAM 1080 are within the scope and the spirit of the invention.

Referring to further aspects of terminal 1000, lens assembly 200 can be adapted for focusing an image of a decodable indicia 15 located within a field of view 1240 on a substrate, T, onto image sensor array 1033. A size in paper space of a field of view 1240 of terminal 1000 can be varied in a number of alternative ways. A size in target space of a field of view 1240 can be varied e.g. by changing a terminal to target distances, changing an imaging lens setting, changing a number of pixels of image sensor array 1033 that are subject to read out. Imaging light rays can be transmitted about imaging axis 25. Lens assembly 200 can be adapted to be capable of multiple focal lengths and multiple planes of optical focus (best focus distances).

Terminal 1000 can include an illumination subsystem 800 for illumination of target, T, and projection of an illumination pattern 1260. Illumination pattern 1260, in the embodiment shown can be projected to be proximate to but larger than an area defined by field of view 1240, but can also be projected in an area smaller than an area defined by a field of view 1240. Illumination subsystem 800 can include a light source assembly 500 comprising one or more light source banks, each comprising one or more light sources, e.g. light sources 502, 504 as shown in the embodiment of FIG. 2 or light source 506 as shown in the embodiment of FIG. 3. In one embodiment, illumination subsystem 800 can also include an illumination lens assembly 300, as is shown in the embodiment of FIG. 3. In addition to or in place of illumination lens array 300 illumination subsystem 800 can include alternative light shaping optics, e.g. one or more diffusers, mirrors and prisms. In use, terminal 1000 can be oriented by an operator with respect to a target, T, (e.g., a piece of paper, a package, another type of substrate) bearing decodable indicia 15 in such manner that illumination pattern 1260 is projected on a decodable indicia 15. In the example of FIG. 2, decodable indicia 15 is provided by a 1D bar code symbol. Decodable indicia 15 could also be provided by a 2D bar code symbol or optical character recognition (OCR) characters. Referring to further aspects of terminal 1000, lens assembly 200 can be controlled with use of electrical power input unit 1202 which provides energy for changing a plane of optimum focus of lens assembly 200. In one embodiment, an electrical power input unit 1202 can operate as a controlled voltage source, and in another embodiment, as a controlled current source. Illumination subsystem light source assembly 500 can be controlled with use of light source control circuit 1206. Electrical power input unit 1202 can apply signals for changing optical characteristics of lens assembly 200, e.g., for changing a focal length and/or a best focus distance of (a plane of optimum focus of) lens assembly 200. Light source control circuit 1206 can send signals to illumination pattern light source assembly 500, e.g., for changing a level of illumination output by illumination pattern light source assembly 500.

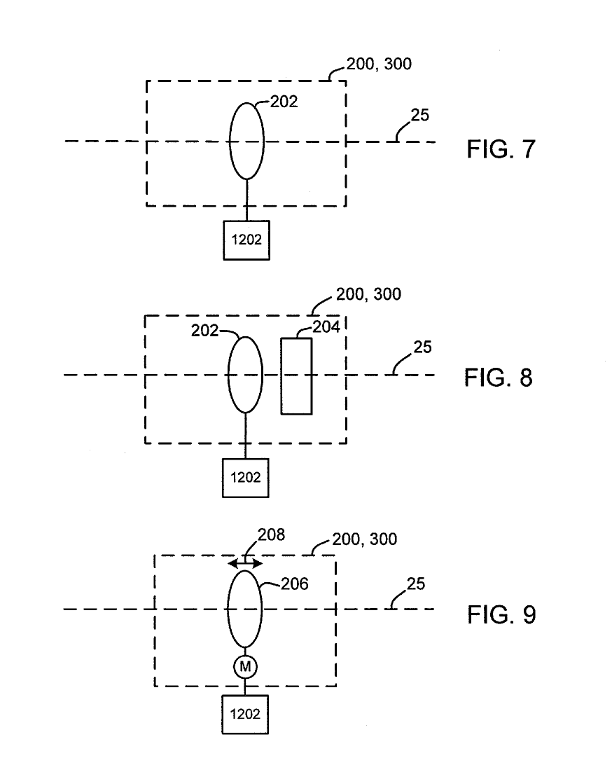

Various embodiments for lens assemblies for use as lens assembly 200 or lens assembly 300 are now described. In the embodiment of FIG. 7, lens assembly 200, 300 comprises a fluid lens 202. Fluid lens 202 in one embodiment can be an electrowetting fluid lens comprising a plurality of immiscible optical fluids. Fluid lens 202 in one embodiment can be provided by an ARCTIC 314 or ARCTIC 316 fluid lens of the type available from VARIOPTIC S.A. of Lyon, France. Fluid lens 202 can alternatively be a fluid lens of the type having a deformable surface, and can be provided in association with a mechanical actuator assembly (not shown) coupled to power input unit 1202.

Referring to FIG. 8, lens assembly 200, 300 can include one or more lenses in series with fluid lens 202. In the embodiment of FIG. 8, lens 204 can be e.g., a glass or polycarbonate lens, or a fluid lens. In the embodiment of FIG. 9, lens assembly 200, 300 comprises a mechanically movable lens 206. Lens 206, in one embodiment, can be provided by solid light transmissive material e.g., glass or polycarbonate, and can be moved with use of motor force provided by motor, M, coupled to power input unit 1202. In one embodiment, motor, M, can be provided by a hollow stepper motor and lens 206 can be disposed within such hollow stepper motor so that lens 206 is moved between various positions along axis 25 as is indicated by bidirectional arrow 208. Lens assembly 200 as shown in FIG. 9 can also include additional lenses such as lens 204 disposed in series with lens 206. With reference to FIGS. 7, 8, 9, imaging lens assembly 200, in one embodiment, can be configured as a positive lens and illumination lens assembly 300, in one embodiment can be configured as a negative lens. Lens assembly 200 and lens assembly 300 can have similar configurations or can be differently configured; e.g., one of the lens assemblies 200 or 300 can have a configuration in accordance with a first of the configurations of FIGS. 7, 8, and 9, and another one of lens assembly 200 or 300 can have a configuration in accordance with a second of the configurations of FIGS. 7, 8, and 9.

Terminal 1000 can also include a number of peripheral devices including trigger 1220 which may be used to make active a trigger signal for activating frame readout and/or certain decoding processes. Terminal 1000 can be adapted so that activation of trigger 1220 activates a trigger signal and initiates a decode attempt. Specifically, terminal 1000 can be operative so that in response to activation of a trigger signal, a succession of frames can be read out and captured by way of read out of image information from image sensor array 1033 (typically in the form of analog signals) and then storage of the image information after conversion into memory 1080 (which can buffer one or more of the succession of frames at a given time). CPU 1060 can be operative to subject one or more of the succession of frames to a decode attempt.

For attempting to decode a bar code symbol, e.g., a one dimensional bar code symbol, CPU 1060 can process image data of a frame corresponding to a line of pixel positions (e.g., a row, a column, or a diagonal set of pixel positions) to determine a spatial pattern of dark and light cells and can convert each light and dark cell pattern determined into a character or character string via table lookup. Where a decodable indicia representation is a 2D bar code symbology, a decode attempt can comprise the steps of locating a finder pattern using a feature detection algorithm, locating matrix lines intersecting the finder pattern according to a predetermined relationship with the finder pattern, determining a pattern of dark and light cells along the matrix lines, and converting each light pattern into a character or character string via table lookup.

Terminal 1000 can include various interface circuits for coupling various of the peripheral devices to system address/data bus (system bus) 1500, for communication with CPU 1060 also coupled to system bus 1500. Terminal 1000 can include interface circuit 1028 for coupling image sensor timing and control circuit 1038 to system bus 1500, interface circuit 1102 for coupling electrical power input unit 1202 to system bus 1500, interface circuit 1106 for coupling illumination light source bank control circuit 1206 to system bus 1500, and interface circuit 1120 for coupling trigger 1220 to system bus 1500. Terminal 1000 can also include a display 1222 coupled to system bus 1500 and in communication with CPU 1060, via interface 1122, as well as pointer mechanism 1224 in communication with CPU 1060 via interface 1124 connected to system bus 1500. Terminal 1000 can also include range detector unit 1208 coupled to system bus 1500 via interface 1108.

A succession of frames of image data that can be captured and subject to the described processing can be full frames (including pixel values corresponding to each pixel of image sensor array 1033 or a maximum number of pixels read out from array 1033 during operation of terminal 1000). A succession of frames of image data that can be captured and subject to the described processing can also be “windowed frames” comprising pixel values corresponding to less than a full frame of pixels of image sensor array 1033. A succession of frames of image data that can be captured and subject to the described processing can also comprise a combination of full frames and windowed frames. A full frame can be captured by selectively addressing for read out pixels of image sensor 1032 having image sensor array 1033 corresponding to the full frame. A windowed frame can be captured by selectively addressing for read out pixels of image sensor 1032 having image sensor array 1033 corresponding to the windowed frame. In one embodiment, a number of pixels subject to addressing and read out determine a picture size of a frame. Accordingly, a full frame can be regarded as having a first relatively larger picture size and a windowed frame can be regarded as having a relatively smaller picture size relative to a picture size of a full frame. A picture size of a windowed frame can vary depending on the number of pixels subject to addressing and readout for capture of a windowed frame.

Terminal 1000 can capture frames of image data at a rate known as a frame rate. A typical frame rate is 60 frames per second (FPS) which translates to a frame time (frame period) of 16.6 ms. Another typical frame rate is 30 frames per second (FPS) which translates to a frame time (frame period) of 33.3 ms per frame. A frame rate of terminal 1000 can be increased (and frame time decreased) by decreasing of a frame picture size.

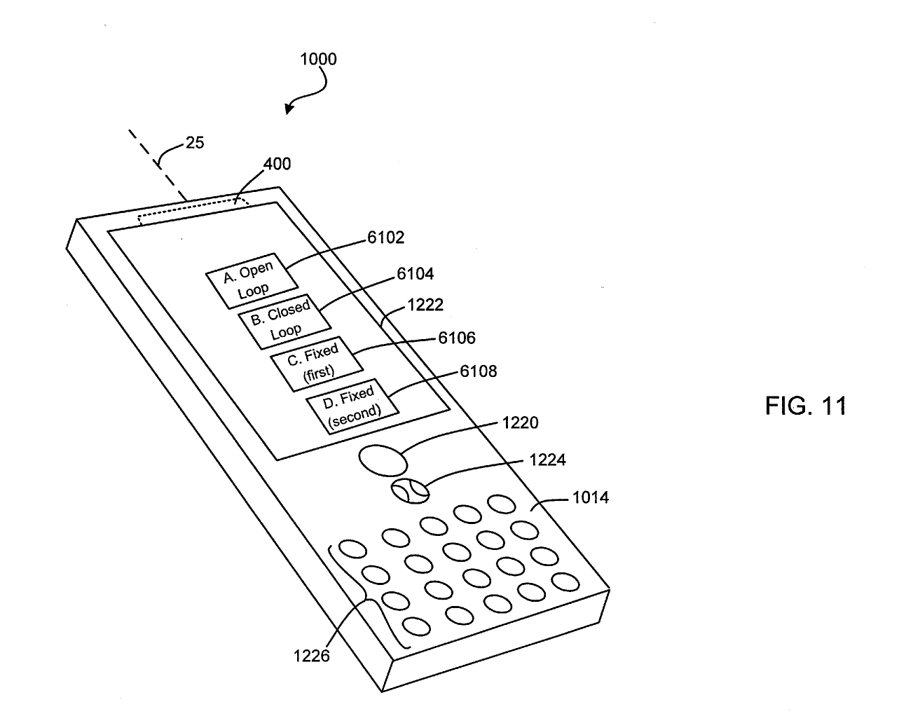

A physical form view of terminal 1000 in one embodiment is shown in FIG. 11. Trigger 1220, display 1222, pointer mechanism 1224, and keyboard 1226 can be disposed on a common side of a hand held housing 1014 as shown in FIG. 6. Display 1222 and pointer mechanism 1224 in combination can be regarded as a user interface of terminal 1000. Display 1222 in one embodiment can incorporate a touch panel for navigation and virtual actuator selection in which case a user interface of terminal 1000 can be provided by display 1222. A user interface of terminal 1000 can also be provided by configuring terminal 1000 to be operative to be reprogrammed by decoding of programming bar code symbols. A hand held housing 1014 for terminal 1000 can in another embodiment be devoid of a display and can be in a gun style form factor. Imaging module 400 including image sensor array 1033 and imaging lens assembly 200 can be incorporated in hand held housing 1014.

Referring to terminal 1000, terminal 1000 can be operative to change a lens setting of lens assembly 200 between at least a first plane of optimum focus setting (best focus distance setting) and a second plane of optimum focus setting. Indicia reading terminal 1000 can be operative to change a lens setting of the lens assembly 200 between at least first and second different planes of optimum focus settings, and can further be operative to expose a first frame of image data with the lens assembly 200 at the first plane of optimum focus setting and expose a second frame of image data with the lens assembly at the second plane of optimum focus setting, and the terminal can further be configured so that the terminal is operative to subject each of the first and second frames of image data to a decode attempt for decoding of a decodable indicia. The second frame can be a successive frame in relation to the first frame or a non-successive subsequent frame in relation to the first frame. Also, the first and second frames of image data can be exposed, captured, and processed during a single trigger signal activation period (decoding sessions), or alternatively, separate trigger signal activation periods (decoding sessions). As indicated a read attempt can be commenced by activation of a trigger signal resulting from depression of a trigger and can be ceased by deactivation of a trigger signal resulting e.g., from a release of a trigger, an expiration of a timeout period, a successful decode.

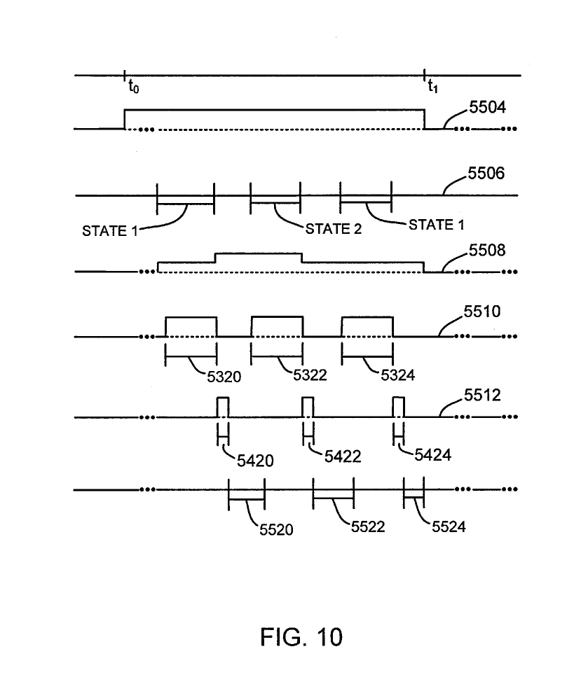

Referring to the timing diagram of FIG. 10, signal 5504 is a trigger signal which can be made active by actuation of trigger 1220, and which can be deactivated by releasing of trigger 1220. A trigger signal may also become inactive after a time out period or after a successful decode of a decodable indicia. Timeline 5506 indicates a state of illumination subsystem 800. Signal 5508 represents an energy input level input into lens assembly 200 of terminal 1000. Signal 5510 is an exposure signal. Logic high periods of signal 5510 define exposure periods 5320, 5322, and 5324. Signal 5512 is a read out signal. Logic high periods of signal 5512 define read out periods 5420, 5422, and 5424. In the described example, a nearer plane of optimum focus lens setting is active during exposure periods 5320 and 5324, and a farther plane of optimum focus lens setting is active during exposure periods 5322 during which period illumination state 2 is active.

Referring to processing periods 5520, 5522, 5524, the noted processing periods can represent processing periods during which time CPU 1060 of terminal 1000 processes stored (e.g., buffered) frames representing a substrate that can bear decodable indicia. Such processing can include processing for attempting to decode a decodable indicia as described herein.

With further reference to the timing diagram of FIG. 10, an operator at time, t₀, can activate trigger signal 5504 (e.g., by depression of trigger 1220). In response to trigger signal 5504 being activated, terminal 1000 can expose a succession of frames. During each exposure period 5320, 5322, 5324 a frame of image data can be exposed.

Referring further to the timing diagram of FIG. 10, a state of illumination subsystem 800 can be changed between exposure periods 5320, 5322, 5324. In the described example, state 1 of illumination subsystem 800 is active during exposure periods 5320 and 5324, and state 2 of illumination subsystem 800 is active during exposure period 5322 the energy input level input for establishing a setting of lens assembly 200 as represented by signal 5508 may be changed between respective exposure period 5320, 5322, 5324. At time t₁, trigger signal 5506 can be deactivated e.g., by successful decode, a timeout condition being satisfied, or a release of trigger 1220.

Referring to signal 5508, signal 5508 can be established at an energy level corresponding to the selected lens setting. Referring to exposure periods 5320, 5322, 5324, a lens setting of lens assembly 200 can be changed between exposure period 5320 and exposure period 5322 and again between exposure period 5322 and exposure period 5324. In the example of the timing diagram of FIG. 10, terminal 1000 can switch a state of an illumination subsystem 800 and a setting of lens assembly 200 between each successive frame during a single trigger signal activation period. In another example, a state of an illumination subsystem and an associated lens setting can be switched according to another method. Additional examples wherein a terminal 1000 is operative to switch a state of an illumination subsystem and an associated lens setting are set forth with reference to FIG. 11 and Table A.

Referring to FIG. 11 and Table A herein below, indicia reading terminal 1000 can have a plurality of different operator selectable operating configurations. In one example, a user interface display 1222 can display various buttons 6102, 6104, 6106, 6108 corresponding to various configurations allowing an operator to actuate one configuration out of a plurality of configurations. In the described example, a number of configurations are available including “Open Loop,”(Configuration A) “Closed Loop,” (Configuration B) “Fixed (First),” (Configuration C) “Fixed (Second)” (Configuration C).

TABLE A

| | Frame Number | | | | | | | | | |
|---|---|---|---|---|---|---|---|---|---|---|
| Configuration | N − 3 | N − 2 | N − 1 | N | N + 1 | N + 2 | N + 3 | N + 4 | N + 5 | . . . |
| A. Open Loop | Illumination: | Illumination: | Illumination: | Illumination: | Illumination: | Illumination: | Illumination: | Illumination: | Illumination: | . . . |
| | State 1 | State 2 | State 1 | State 2 | State 1 | State 2 | State 1 | State 2 | State 1 | |
| | Lens Setting: | Lens Setting: | Lens Setting: | Lens Setting: | Lens Setting: | Lens Setting: | Lens Setting: | Lens Setting: | Lens Setting: | |
| | Nearer | Farther | Nearer | Farther | Nearer | Farther | Nearer | Farther | Nearer | |
| B. Closed Loop | Illumination: | Illumination: | Illumination: | Illumination: | Illumination: | Illumination: | Illumination: | Illumination: | Illumination: | . . . |
| | State 1 | State 1 | State 1 | State 1 | State 1 | State 2 | State 2 | State 2 | State 2 | |
| | Lens Setting: | Lens Setting: | Lens Setting: | Lens Setting: | Lens Setting: | Lens Setting: | Lens Setting: | Lens Setting: | Lens Setting: | |
| | Nearer | Nearer | Nearer | Nearer | Nearer | Farther | Farther | Farther | Farther | |
| C. Fixed (First) | Illumination: | Illumination: | Illumination: | Illumination: | Illumination: | Illumination: | Illumination: | Illumination: | Illumination: | . . . |
| | State 1 | State 1 | State 1 | State 1 | State 1 | State 1 | State 1 | State 1 | State 1 | |
| | Lens Setting: | Lens Setting: | Lens Setting: | Lens Setting: | Lens Setting: | Lens Setting: | Lens Setting: | Lens Setting: | Lens Setting: | |
| | Nearer | Nearer | Nearer | Nearer | Nearer | Nearer | Nearer | Nearer | Nearer | |
| D. Fixed | Illumination: | Illumination: | Illumination: | Illumination: | Illumination: | Illumination: | Illumination: | Illumination: | Illumination: | . . . |
| (Second) | State 2 | State 2 | State 2 | State 2 | State 2 | State 2 | State 2 | State 2 | State 2 | |
| | Lens Setting: | Lens Setting: | Lens Setting: | Lens Setting: | Lens Setting: | Lens Setting: | Lens Setting: | Lens Setting: | Lens Setting: | |
| | Farther | Farther | Farther | Farther | Farther | Farther | Farther | Farther | Farther | |

With Configuration “Open Loop” active, illumination and imaging lens settings associated with a succession of frames can vary on an open loop basis without regard to a sensed condition. In the described example described with reference to Table A, an imaging lens setting and associated illumination state alternate between successive frames. The period of change in the example of Table A is P=1, one frame with lens setting nearer, illumination state 1, one frame with lens setting farther, illumination state 2, and so on. The period could also be set to another value, e.g., P=2, P=M, and can vary during a trigger signal activation period (decoding session.) Operation in accordance with Configuration “Open Loop” is depicted in the timing diagram of FIG. 10. With reference to the timing diagram of FIG. 10 it is seen that a first lens setting is associated to a first illumination state for exposure periods 5320 and that a second lens setting is associated to a second illumination state for exposure period 5322.

With Configuration “Closed Loop” active, illumination, and imaging lens settings associated with a succession of frames can vary on a closed loop basis, i.e., can change responsively to a sensed condition. A sensed condition can be e.g., an expiration of a timeout, e.g., terminal 1000 can be operative so that an illumination subsystem state and an associated lens setting can change responsively to a first timeout conditionally on the condition that the terminal does not decode a decodable indicia prior to expiration of the first timeout, and a trigger signal can be deactivated responsively to a second timeout. A sensed condition can also be a sensed terminal to target distance. As indicated in the block diagram of FIG. 6, terminal 1000 can include a range detector unit 1208 for detecting a terminal to target distance. Range detector unit 1208 can be an ultrasonic range detector, or may comprise a laser aimer which projects light into a field of view which can be detected for range determination based on the post of the projected light in a frame captured with use of image sensor array 1033. If terminal 1000 senses that it is at a nearer terminal to target distance, terminal 1000 can establish lens setting of lens assembly 200 at a first setting and set an illumination state of illumination subsystem 800 to a first state. If terminal 1000 senses that it is at a farther terminal to target distance, it can establish a lens setting at a second farther plane of optimum focus setting and can set the illumination subsystem to a second state. In Table A, configuration “Closed Loop” is depicted by a switching from Illumination State 1 to State 2; however, the switch of the illumination subsystem state in Configuration B “Closed Loop” could also be from State 2 to State 1.

With Configuration “Fixed (first)” active terminal 1000 can establish a lens setting and an illumination state of illumination subsystem 800 at a first setting and state respectively for each frame exposed during a trigger signal activation period.

With Configuration “Fixed (second)” active terminal 1000 can establish a lens setting and an illumination state of illumination subsystem 800 at a second setting and state respectively for each frame exposed during a trigger signal activation period.

Referring to Table A, the frames N−3, N−2, N−1 . . . depicted in Table A are a succession of frames exposed, read out and subject to processing during a time that trigger signal 5504 is active. The processing of each frame depicted in table A can include a decode attempt as described herein. As explained a trigger signal 5504 can be made active by depression of trigger 1220 and can be de-activated by release of trigger 1220 or a successful decode or expiration of a timeout. For the succession of frames in the Table A under each configuration there is described a succession of frames where a certain lens setting during an exposure period is associated to a certain illumination state. Frames exposed during a trigger signal activation period can have the characteristics as depicted in Table A, namely with frames having nearer focus lens setting associated to a first illumination state and frames having farther focus lens settings associated to a second illumination state. Nevertheless it is understood that additional frames exposed during a trigger signal activation period, (e.g., before frame N−3, after frame N+5) can have characteristics other than those depicted in table A.

It has been described that a first frame and a second frame can be subject to a decode attempt where the first frame is exposed with the lens setting at a first lens setting and illumination subsystem at a first illumination state and the first frame is exposed with the lens setting at a first lens setting and illumination subsystem at a first illumination state. With reference to Configurations A and B it is seen that the first and second frames can be exposed and captured in a single trigger signal activation period. With reference to the Configurations B and C it is sent that the first and second frames can be exposed, captured, and processed in different trigger signal activation periods. A trigger signal can be activated with the Configuration C active for exposure capture and processing of the first frame and then deactivated. Terminal 1000 can be switched to Configuration D and then trigger signal 5504 activated again for exposure capture and processing of a second frame.

It has been described that an exposed frame of image data can have an associated imaging lens assembly lens setting that is associated to a certain illumination state. In another aspect there can be associated to a certain imaging lens assembly lens setting and illumination state a certain picture size. In one embodiment, frames exposed with second (farther lens setting) active and an associated second illumination state active can have an associated second picture size that is smaller than a first picture size associated with frames exposed with a first imaging lens assembly lens setting and first illumination state active.

The second picture size can be yielded by readout of a windowed frame of image data read out by selective addressing and readout of center pixel pixels of image sensor array 1033, i.e., 1 to 100 center rows of pixels, a rectangular pattern, e.g., a 300×50 pixel rectangle pattern of contiguous pixels including a center pixel of image sensor array 1033.

Regarding examples provided herein, it will be understood that illumination subsystem 800 can be provided to have one or more additional illumination states, (e.g., a third state, a fourth state, etc.) each additional illumination state corresponding to a projection angle of αᵢ where α₁>αᵢ>α₂. Like the first and second illumination states, each additional illumination state can be associated to a particular lens setting of lens assembly 200, the particular lens setting establishing a plane of optimum focus intermediate of the previously described “nearer” and “farther” planes of optimum focus.

A small sample of systems methods and apparatus that are described herein is as follows:

A1. An indicia reading terminal comprising:

an illumination subsystem for projection of an illumination pattern, the illumination subsystem having at least one light source, the illumination subsystem being switchable between a first state and a second state, wherein the illumination subsystem in the second state projects illumination light at a projection angle that is more narrow than a projection angle of illumination light projected by the illumination subsystem when the illumination subsystem is in the first state;

an imaging subsystem including an image sensor array and an imaging lens assembly for focusing an image of a target onto the image sensor array, the imaging lens assembly being a variable imaging lens assembly and having a first lens setting at which the imaging lens assembly has a relatively nearer plane of optimum focus and a second lens setting at which the imaging lens assembly has a relatively farther plane of optimum focus;

a hand held housing incorporating the image sensor array;

wherein the indicia reading terminal is operative so that during exposure periods of the image sensor array with the first lens setting active the first state of the illumination subsystem is active and further so that during exposure periods of the image sensor array with the second lens setting active the second state of the illumination subsystem is active;

wherein the indicia reading terminal is operative to expose a first frame of image data with the first lens setting and first state active, and a second frame of image data with the second lens setting and second state active;

wherein the indicia reading terminal is operative to attempt to decode a decodable indicia utilizing each of the first frame of image data and the second frame of image data.

A2. The indicia reading terminal of A1, wherein the illumination subsystem includes a first light source bank and a second light source bank, the first light source bank being energized and the second light source bank being de-energized when the illumination subsystem is in the first operating state, the first light source bank being de-energized and the second light source bank being energized when said illumination subsystem is in the second state, wherein a light source of a second light source bank includes a narrower projection angle than a light source of the first light source bank.
A3. The indicia reading terminal of A2, wherein the first light source bank includes a single light source.
A4. The indicia reading terminal of A1, wherein the illumination subsystem includes a variable illumination lens having a first illumination lens settings for activation of the first state and a second illumination lens setting for activation of the second state.
A5. The indicia reading terminal of A1, wherein the indicia reading terminal is operative so that the first frame and the second frame are successive frames captured during a single trigger signal activation period.
A6. The indicia reading terminal of A1, wherein the terminal is operative so that the second frame is exposed subsequent to the first frame.
A7. The indicia reading terminal of A1, wherein the indicia reading terminal is operative so that the first frame and the second frame are non-successive frames captured during a single trigger signal activation period.
A8. The indicia reading terminal of A1, wherein the indicia reading terminal is operative so that the first frame and the second frame are frames captured during different trigger signal activation periods.
A9. The indicia reading terminal of A1, wherein the indicia reading terminal is further operative so that there is associated to the second frame of image data a smaller picture size than a picture size of the first frame of image data.
A10. The terminal of A1, wherein the terminal includes a range detector unit for use in detecting a terminal to target distance, and wherein the indicia reading terminal is operative to switch the illumination subsystem between the first state and the second state responsively to an output of the range detector unit.
A11. The terminal of A10, wherein the indicia reading terminal is operative to switch the illumination subsystem from the first state to the second state responsively to an output of the range detector.
A12. The terminal of A1, wherein the terminal is operative so that the first frame and the second frame are captured during a single trigger activation period, and wherein the terminal is operative so that the illumination subsystem switches between the first state and the second state responsively to a timeout conditionally on the condition that the terminal does not decode a decodable indicia prior to expiration of the timeout.
A13. The terminal of A1, wherein the terminal is operative so that the first frame and the second frame are captured during a single trigger signal activation period, and wherein the terminal is further operative so that the terminal switches the illumination subsystem between the first state and the second state on an open loop basis during the single trigger signal activation period.
A14. The terminal of A1, wherein the illumination subsystem has a third state in which illumination light projected by the illumination subsystem is projected at an angle that is narrower than an angle of projected illumination in the first state and wider than an angle of projected illumination in the second state.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than or greater than the mentioned certain number of elements. Also, while a number of particular embodiments have been described, it will be understood that features and aspects that have been described with reference to each particular embodiment can be used with each remaining particularly described embodiment.

We claim:

1. An indicia reading terminal comprising:
an illumination subsystem for projection of an illumination pattern, the illumination subsystem having at least one light source, the illumination subsystem being switchable between a first state and a second state, wherein the illumination subsystem in the second state projects illumination light at a projection angle that is more narrow than a projection angle of illumination light projected by the illumination subsystem when the illumination subsystem is in the first state;
an imaging subsystem including an image sensor array and an imaging lens assembly for focusing an image of a target onto the image sensor array, the imaging lens assembly being a variable imaging lens assembly and having a first lens setting at which the imaging lens assembly has a relatively nearer plane of optimum focus and a second lens setting at which the imaging lens assembly has a relatively farther plane of optimum focus;
a hand held housing incorporating the image sensor array;
wherein the indicia reading terminal is operative so that during exposure periods of the image sensor array with the first lens setting active the first state of the illumination subsystem is active and further so that during exposure periods of the image sensor array with the second lens setting active the second state of the illumination subsystem is active;
wherein the indicia reading terminal is operative to expose a first frame of image data with the first lens setting and first state active, and a second frame of image data with the second lens setting and second state active;
wherein the indicia reading terminal is operative to attempt to decode a decodable indicia utilizing each of the first frame of image data and the second frame of image data.

2. The indicia reading terminal of claim 1, wherein the illumination subsystem includes a first light source bank and a second light source bank, the first light source bank being energized and the second light source bank being de-energized when the illumination subsystem is in the first operating state, the first light source bank being de-energized and the second light source bank being energized when said illumination subsystem is in the second state, wherein a light source of a second light source bank includes a narrower projection angle than a light source of the first light source bank.

3. The indicia reading terminal of claim 2, wherein the first light source bank includes a single light source.

4. The indicia reading terminal of claim 1, wherein the illumination subsystem includes a variable illumination lens assembly having a first illumination lens settings for activation of the first state and a second illumination lens setting for activation of the second state.

5. The indicia reading terminal of 1, wherein the indicia reading terminal is operative so that the first frame and the second frame are successive frames captured during a single trigger signal activation period.

6. The indicia reading terminal of claim 1, wherein the terminal is operative so that the second frame is exposed subsequent to the first frame.

7. The indicia reading terminal of claim 1, wherein the indicia reading terminal is operative so that the first frame and the second frame are non-successive frames captured during a single trigger signal activation period.

8. The indicia reading terminal of claim 1, wherein the indicia reading terminal is operative so that the first frame and the second frame are frames captured during different trigger signal activation periods.

9. The indicia reading terminal of claim 1, wherein the indicia reading terminal is further operative so that there is associated to the second frame of image data a smaller picture size than a picture size of the first frame of image data.

10. The terminal of claim 1, wherein the terminal includes a range detector unit for use in detecting a terminal to target distance, and wherein the indicia reading terminal is operative to switch the illumination subsystem between the first state and the second state responsively to an output of the range detector unit.

11. The terminal of claim 10, wherein the indicia reading terminal is operative to switch the illumination subsystem from the first state to the second state responsively to an output of the range detector.

12. The terminal of claim 1, wherein the terminal is operative so that the first frame and the second frame are captured during a single trigger activation period, and wherein the terminal is operative so that the illumination subsystem switches between the first state and the second state responsively to a timeout conditionally on the condition that the terminal does not decode a decodable indicia prior to expiration of the timeout.

13. The terminal of claim 1, wherein the terminal is operative so that the first frame and the second frame are captured during a single trigger signal activation period, and wherein the terminal is further operative so that the terminal switches the illumination subsystem between the first state and the second state on an open loop basis during the single trigger signal activation period.

14. The terminal of claim 1, wherein the illumination subsystem has a third state in which illumination light projected by the illumination subsystem is projected at an angle that is narrower than an angle of projected illumination in the first state and wider than an angle of projected illumination in the second state.
